(19) United States
(12) Patent Application Publication
(10) Pub. No.: US 2018/0244107 A1
(43) Pub. Date: Aug. 30, 2018

(54) CUSHION TIRE

(71) Applicant: Tomo BONAC, Vancouver, British Columbia (CA)

(72) Inventor: Tomo BONAC, Vancouver, British Columbia (CA)

(21) Appl. No.: 15/755,299

(22) PCT Filed: Aug. 31, 2016
(86) PCT No.: PCT/CA2016/000221

§ 371 Date: Feb. 26, 2018

(30) Foreign Application Priority Data
Aug. 31, 2015 (CA) 2902079

(51) Int. Cl. B60C 7/24; B60C 7/14

(52) U.S. Cl. CPC B60C 7/24; B60C 2200/12; B60C 7/14

(57) ABSTRACT

A replaceable non-pneumatic vehicle tire which comprises a resilient tire band attached to the outer face of the wheel rim. Conformity to the ground surface is accomplished with use of compression elastomer springs bonded to the tire band. Tire band is secured by fitting circumferential beads of the band into undercut grooves located on the outer face of the wheel rim. It can be also secured using simple V-grooves provided to the wheel rim. The tire is compact and easy to manufacture. It can be engineered to have improved rolling resistance and grip to the ground surface.

### FIELD OF INVENTION

The present invention relates to a replaceable non-pneumatic wheel tire for vehicles. More particularly, this invention pertains to a portion of the tire, at the periphery of the wheel which is performing cushioning and adapting to the ground surface.

### BACKGROUND OF THE INVENTION

The pneumatic tire is presently used universally as peripheral part of a vehicle wheel. Such tire not only transmits vehicle propelling forces and braking forces but also partially act as a vehicle suspension by shock absorption and by conforming to the ground surface. The design of the pneumatic tire for a specific application is mostly determined by the air pressure in the tire. If more conforming to the ground is required, a lower air pressure is applied. This improves the suspension performance but increases the rolling energy losses due to hysteresis of viscoelastic tire material which dissipates some of the energy supplied to rolling in the form of heat. The use of a higher air pressure reduces the conforming and suspension. However, the unfortunate situation is that air pressure in a pneumatic tire is not constant but is influenced by operating conditions as well as it is subjected to leaks and punctures. All this leads to substantial rolling energy losses of pneumatic tires in general. Further disadvantage of the pneumatic tire is that the whole tire needs to be discarded even when the main wear is limited only to the thread. This is costly and it causes environmental problems of discarded tires.

The deficiencies of pneumatic tire are particularly acute for the bicycle tires where propelling energy is at a premium. Work by the Wheel Energy Laboratory provides insight into the mechanism of wheel rolling energy losses. Most are caused by casing deformation at the tire contact with the ground. The casing bulges, bending the canvas (i.e. incorporated cloth or fibre strands preventing stretching) on leading and trailing end of the contact with the ground. Such energy losses have the same general effect on energy consumption as climbing the grade. Furthermore, the strands are forced to spread and bend additionally in the lateral walls of the portion of the tire strands take place during bulging. Situation is made worse when driving torque is applied to the wheel because most of the forces are transmitted by the casing, causing additional bulging of the tire. Not only does this increase the rolling losses but also negatively impacts wear of the thread of the tire. Some improvement can be made by optimizing tire pressure, tire width, wheel diameter, rubber content, and canvas thread count; all balanced against the aerodynamic losses. However, the improvements arc limited and lead to more expensive tires and wheels. An extreme case is Gokiso wheel where low rolling losses arc achieved by increasing tire pressure and wheel rigidity while transferring suspension function to the axle. The above mentioned problems are all inherent to pneumatic tires. Better solutions could be provided by non-pneumatic tires.

The non-pneumatic tires have the inherent advantages of being puncture proof and they have relatively stable operational properties. However, to surpass the performance of pneumatic tires, a non-pneumatic tire would also need to have the following advantages: the use of elastomer with low viscoelastic hysteresis, minimal use of canvas, low mass, small width, low cost, easy replaceability, good recyclability, and ability to use high friction material at the contact with the road surface. Prior art does not disclose a non-pneumatic tire with such features.

A number of non-pneumatic tires provide solutions specifically designed to reduce tire rolling losses. Some arc limited to use of elastic spring elements, mostly metallic, incorporated into a traditional tire. Radially flexing leaf springs are shown in U.S. Pat. No. 479,851, FR980322A, U.S. Pat. No. 6,994,135 and U.S. Pat. No. 6,374,887B1. Applications of coil springs arc shown in U.S. Pat. No. 573, 920 and KR100901249B1 and application of membrane springs is disclosed in US2010/0013293A1. The advantages arc that spring elements have low hysteresis. However, the main disadvantages of this group of inventions are that they lead to a relatively heavy tire and an expensive product.

Other inventions simply provide axial and radial holes or pockets as well as circumferential grooves to a solid or composite elastomer body to achieve cushioning performance of the tire. Examples are U.S. Pat. No. 466.112, U.S. Pat. No. 690,287, U.S. Pat. No. 912,943, U.S. Pat. No. 982,634, U.S. Pat. No. 1,241,380, U.S. Pat. No. 1,378,832, and U.S. Pat. No. 8,567,461. In spite of the fact that the desirable cushioning properties arc achieved by hollowing of elastomer material, this approach still leads to a relatively heavy tire. Also, rolling energy losses are not significantly reduced because relatively large sections of the tire made from viscoelastic material, are deformed.

One invention, disclosed in U.S. Pat. No. 485,633, however, describes use of a membrane stretched between the flanges of the wheel rim. The membrane is loaded in tension to achieve cushion action of the tire. In principle this is an improvement since it reduces the mass of the tire and increases the range of wheel suspension. However, the disadvantage of this tire is that it has poor ability of shock absorption ability.

### SUMMARY OF THE INVENTION

Accordingly, one object of the present invention is to create non-pneumatic tire as a one piece replaceable component of a wheel with improved conformity to the road and reduced rolling energy losses.

The non-pneumatic tire is constructed as a band rather than as a tubular object. This approach leads to more compact design allowing reduction of mass and smaller tire width. in order to achieve the objective of improving conformity of the tire to the ground, one or more elastomeric (elastic substance) compression springs are placed circumferentially between the outer face of the wheel rim and the inner surface of the tire band. The compression springs are bonded to the inner surface of the tire band rather than to the wheel rim. This allows tires with different properties to be used on the same wheel. Tires which are selected for cushioning or, winter tires, can be mounted on the same wheel rim. Since the band and the elastomer springs can be made in a single process, inexpensive manufacturing process can be used. The compression springs arc oriented in such a way to act mainly in the wheel radial direction. Since there are small stresses in the band, minimal use of canvas is required which further simplifies the manufacturing process. Additional compactness of the tire is achieved by incorporating the means to secure the tire to the wheel rim and the elastomeric springs together into the tire band. The means are designed to attach the tire removably, but also to act as compression springs themselves, even when the wheel leans on curves in the path. The elastomeric springs consists of ridges or radial plane. The compression springs can be constructed from material selected for the elastic function. The outer surface of the tire band which is usually provided with a thread can also be made from specialized material. Elastic materials with low hysteresis can be used for the compressive layer thus reducing the rolling energy losses. Low friction material can be used for the thread. Another advantage of compression springs is that the distribution of forces within the contact with the ground is non-uniform. Larger compression forces are at the center of the contact than at the periphery. This reduces bulging of the tire, improves efficiency of driving torque, improves the grip, and also improves the wear of the tire thread. Furthermore, the shape of the tire contact with the ground can be engineered by varying size, shape. and number of the elastomer springs, all affecting the rolling performance.

According to one embodiment in accordance with the invention, the tire is provided circumferentially with one or more beads on the inner surface of the band, next to the compression springs. The beads secure the tire and allow its replacement. The tire is attached by pressing the beads into the corresponding undercut grooves of the wheel rim outer face. The grooves have openings smaller than the size of the beads assuring their retention after pressing in. To remove the tire, it can be cut transversely or pried and pulled away from the undercut grooves of the wheel. One advantage is that the compression springs and the securing beads can be close to each other thus allowing the tire to be narrower, more compact and lighter. Another advantage is achieved by placing the beads at the edge of the tire band so that the beads themselves can take some of the tire cushioning function when the vehicle wheel leans in the curve of the path.

According to another embodiment in accordance with the invention, the vehicle wheel rim outer face is provided circumferentially with opposing undercuts. Correspondingly, the tire band is provided with beads which secure, removably, the tire by their engagement into the undercuts of the wheel rim outer face. Attachment is accomplished by engaging the first edge bead under the first undercut of the wheel rim face, by stretching the tire over the face in the axial direction and engaging the second bead of the tire band into the opposing second undercut of the wheel rim face. One advantage of this arrangement is that the width of the tire can be narrower. The other advantage is that the tire is easy to replace.

According to still another embodiment in accordance with the invention, the compression springs act as means of suspension and at the same time secure the tire on the wheel rim. Wheel rim face is provided, circumferentially, with one or more V-grooves, while the tire band inner surface is provided with corresponding ridges to fit the V-grooves. The advantage is compactness of the design. Further advantage is that the ridges can be engineered to act as springs without much rubbing on the V-groove side walls, but can fully engage during wheel braking or acceleration. This reduces the need for reinforcing canvas of the tire.

This summary of the invention does not necessarily describe all features of the invention. In the following, the invention will be described in detail with reference to the drawings.

### BRIEF DESCRIPTION OF THE DRAWINGS

FIG. 1 is a partial perspective view of non-pneumatic tire according to the invention, attached to bicycle wheel rim by pushing in the beads. The tire is fitted with smooth thread.

FIG. 2 is a partial perspective view of non-pneumatic tire with one elastomer spring, attached to bicycle wheel rim by pushing in the beads. The tire is fitted with winter thread.

FIG. 3 is a partial perspective view of non-pneumatic tire with two elastomer springs, attached to bicycle wheel by engaging two opposing undercut beads. The tire is fitted with grooved thread.

FIG. 4 is a partial perspective view of non-pneumatic tire with two elastomer springs, attached to bicycle wheel by fitting into corresponding V-grooves of the wheel rim. Tire without thread is shown.

FIG. 5 is a cross section of non-pneumatic tire at the location of contact with the ground, in agreement with embodiment shown in FIG. 4. Shown is deformation of the tire during coasting of the wheel.

FIG. 6 is a cross section of non-pneumatic tire at the location of contact with the ground, in agreement with embodiment shown in FIG. 4. Shown is tire deformation during wheel breaking, while rolling upright.

FIG. 7 is a cross section of non-pneumatic tire at the location of contact with the ground, in agreement with embodiment shown in FIG. 4. Shown is tire deformation of the tire while rolling inclined to the ground.

### DETAILED DESCRIPTION OF THE PREFERRED EMBODIMENTS

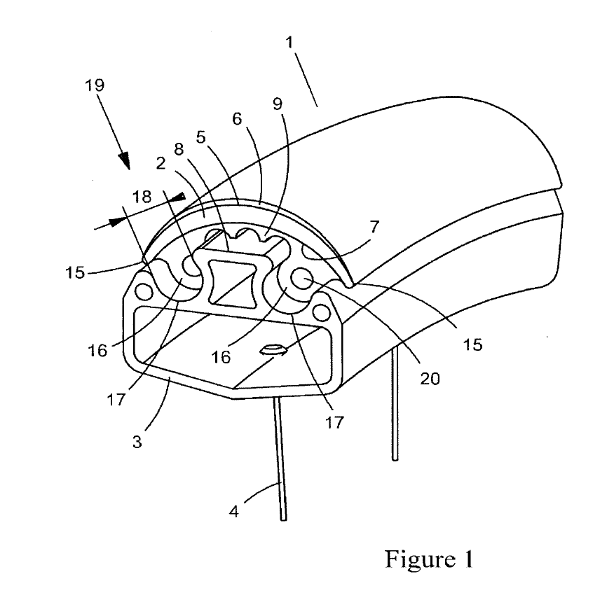

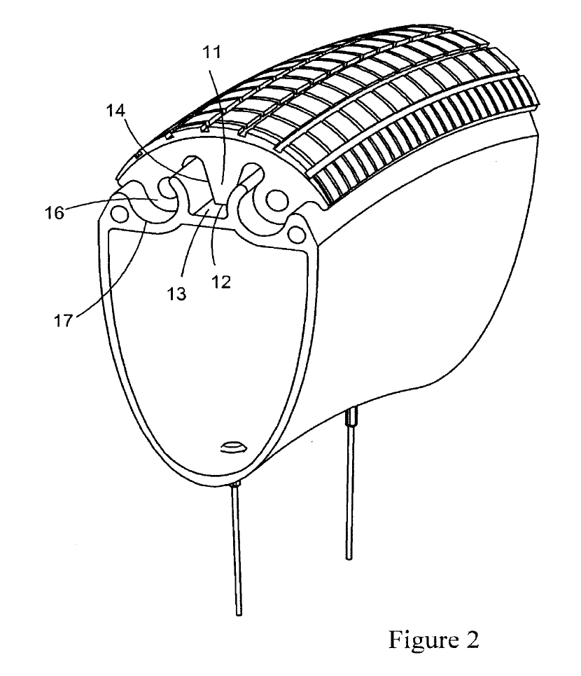

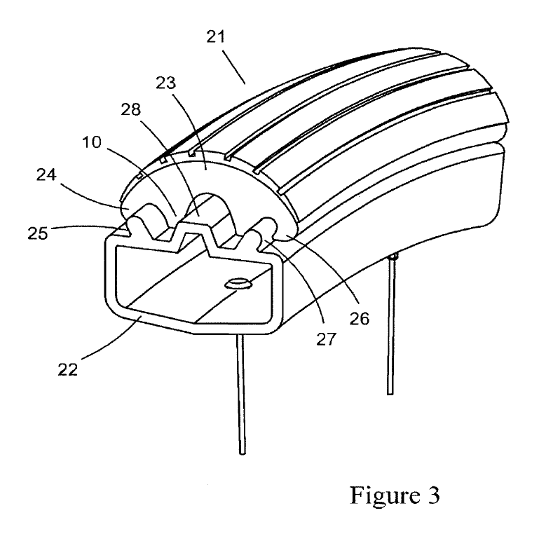

The non-pneumatic tire 1 illustrated in FIG. 1 comprises a stretchable band 2 mechanically attached to a wheel rim 3 which is mounted to a hub of a vehicle wheel with spikes 4. The band has outer surface 5 which is bonded to thread 6 and inner surface 7 which abuts the corresponding face 8 of the wheel rim. In the case of a bicycle tire as shown in FIG. 1 the band is substantially curved along faces 5 and 7 in the wheel axial plane. The curvature is provided due to the characteristic of a bicycle wheel that it can lean substantially relative to the ground on a curved path. To provide conformity to the ground, elastomer springs 9 arc bonded to the inner surface of the tire band. Useful shape of an elastomeric spring is a ridge such as the pair of springs 9 shown in FIG. 1, springs 10 shown in FIG. 3, or a single spring 11 shown in FIG. 2 where the tip of the ridge 12 touches the wheel rim outer face 13. Other forms of elastomer springs may also be beneficial. Shape of springs, spacing, size and pattern does affect the distribution of forces during the contact of the tire to the ground. Size of elastomer spring especially controls the stroke of tire cushion. FIG. 2 depicts a singular spring 11 with taper 14 providing cushion in the centre of the tire. The benefit of the taper is that cushion force progressively increases with stroke thus providing effective shock absorption. One advantage of dedicating wheel cushion function to compression springs is that they can be made from material with low hysteresis. In comparison to pneumatic tires which are made by moulding, the non-pneumatic tire can be extruded, thus lowering the cost of manufacturing. The springs and the band can be co-extruded together with the tire band from different

One preferred method of attaching the wheel tire to the vehicle rim is shown in FIGS. 1 and 2. The tire band 2 is on the inner surface 7, at the edges 15 provided with circumferential beads 16. The beads are preferably made from elastic material and are bonded to the inner surface of the band, or they are co-extruded with the band together with the compression springs. Accordingly, wheel rim is provided on the outer face 8 with circumferential undercut grooves 17 fitting the beads. The grooves have preferably an opening width 18 which is smaller than the diameter of the beads 16. The tire is attached to the wheel rim by first stretching the tire band in the radial direction, then aligning the beads with the grooves in the direction 19 and finally pressing the beads 16 through the opening 18 into the grooves 17. A design with a single groove in the rim outer face is also possible, but in the case of bicycle tire two grooves have an advantage since elastomeric springs arc easily applied between the two beads to the inner surface of the band. Also, the advantage of locating beads at the edge of the tire band is that the beads provide suspension of the tire when the wheel leans in the curved path. The beads can be provided with a cavity 20 to allow easier pressing of the beads into the grooves. The tire is removable by prying the beads from the grooves with a spatula-like tool or by cutting across the beads or the thread with a knife.

A different method of attaching the tire to the wheel rim is shown in FIG. 3. The tire 21 is secured to the outer face of the wheel rim 22 by engaging under the opposing, circumferential undercuts. The tire band 23 is provided at its edges with beads 24 and 26 fitting into the undercuts 25 and 27, respectively. Attaching the tire is accomplished by engaging first the bead 24 under undercut 25 followed by stretching of the tire over the rim face 28 in the wheel axial direction and engaging the second bead 26 of the tire band into the undercut 27. Removal of this stretch-over tire can be accomplished with similar tools or method as for the tire attached by pushing the beads into the grooves. However, the whole procedure of attaching of the stretch-over tire is simplified since the beads tend to snap into the undercuts.

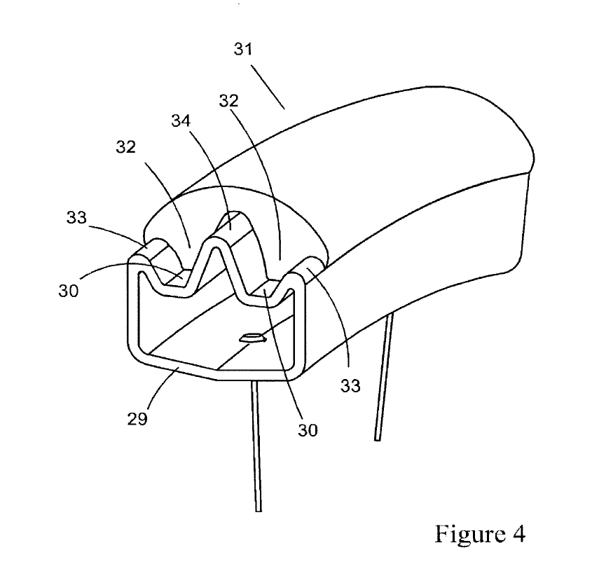

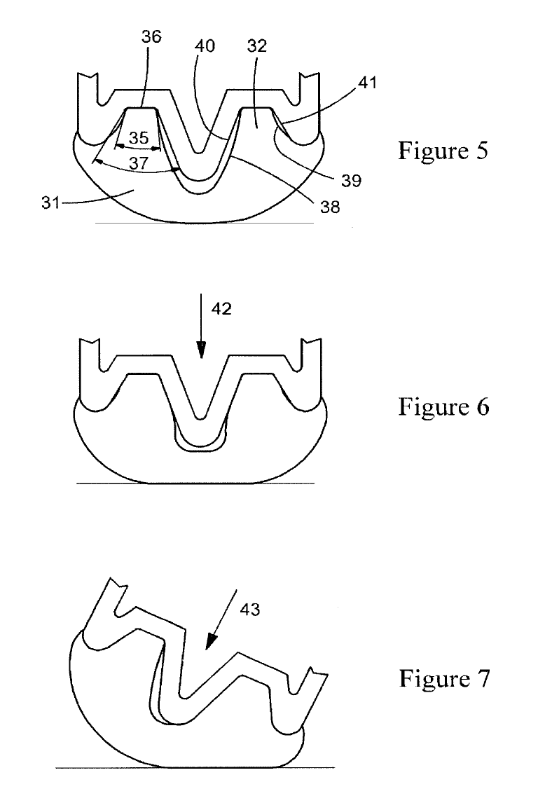

Still different method of attaching the tire to the wheel rim is shown in FIG. 4. The wheel rim 29 is provided on the periphery with two V-grooves 30. Accordingly, tire 31 is provided with two corresponding ridges 32 generally fitting the V-grooves of the wheel rim. The tire is attached to the wheel rim by inserting the ridges 32 into V-grooves 30 at a radial location of the wheel and stretching the tire over crests 33 and 34 at another radial location of the wheel until the ridges completely fit the grooves. The V-grooves have included angle 37 as shown in FIG. 5. Preferably, the fitting ridges of the tire are at the tip of the ridge 36 provided with included angle 35, which is smaller than the included angle 37 of the V-grooves. The advantage of the smaller included angle 35 is that during normal rolling of wheel the sides 38 and 39 of the ridge do not touch the sides 40 and 41 of the V-groove and thus do not cause energy losses. However, during breaking of the wheel or at vertical oscillations of the wheel the ridges deform in the direction 42 and the ridges fully engage with the V-groove allowing effective transmission of torque as shown in FIG. 6. Similarly, when wheel is inclined relative to the ground, the ridge fully engages the V-groove due to force acting in direction 43 as shown in FIG. 7.

What is claimed is:

1. A wheel for vehicles comprising:
a circular rim having outer face in reference to the axis of rotation, and a tire removably attached circumferentially to the said outer face of the rim, said tire comprising:
a band with axis substantially coincident with the axis of the wheel, said band having outer surface and inner surface which abuts the outer face of the rim;
one or more elastomer compression springs applied circumferentially between the inner surface of said band and outer face of the rim, said compression springs bonded to the inner surface of the tire band, and;
securing means to attach the tire band to the rim, said securing means bonded to the inner surface of the tire band, said securing means being constructed from compressible material.

2. The wheel according to claim 1, wherein said outer face of the rim is provided with one or more circumferential grooves, each groove having undercut and opening, said inner surface of tire band having one or more beads, said opening smaller than said bead, said tire being stretchable in the radial direction over said wheel rim outer face and attached to the said outer face by pressing the beads substantially in the radial direction of the wheel through said opening and securable by fitting the beads into corresponding undercut grooves of the rim.

3. The wheel according to claim 1, wherein said outer face of the rim is provided circumferentially with first and second opposing undercuts, respectively; said first and second undercuts being provided to secure the tire, said tire having first and second beads, respectively; said tire attached to said outer face by engaging first bead of the tire into first undercut of the rim outer face, then stretching the tire in the wheel axial direction over the rim outer face, and engaging the second bead of the tire band into the second undercut of the rim face.

4. The wheel according to claim 1, wherein said outer face of the rim is provided circumferentially with one or more V-grooves having included angle, said grooves being provided to secure the tire, said tire having circumferential ridges generally fitting the V-grooves of the rim, said tire attached to said outer face by first engaging the ridges into said V-grooves at a radial location of the wheel, then stretching the tire in the wheel axial direction over the rim outer face at another wheel radial location, until ridges of the tire entirely fit V-grooves of the rim circumferentially.

5. The tire according to claim 4, wherein included angle of said ridges of the tire is smaller than included angle of V-grooves of the wheel rim.
